(19) United States
(12) Patent Application Publication
(10) Pub. No.: US 2014/0280998 A1
(43) Pub. Date: Sep. 18, 2014

(54) CONTROLLING DISTRIBUTION AND ROUTING FROM MESSAGING PROTOCOL

(71) Applicant: CISCO TECHNOLOGY, INC., San Jose, CA (US)

(72) Inventors: TIMOTHY C. RICHARDS, Cumming, GA (US); VIVEK SHANKAR SRIVASTAV, Suwanee, GA (US)

(73) Assignee: CISCO TECHNOLOGY, INC., San Jose, CA (US)

(21) Appl. No.: 13/836,250

(22) Filed: Mar. 15, 2013

(51) Int. Cl. H04L 12/721

(52) U.S. Cl. CPC H04L 45/72
USPC 709/230

(57) ABSTRACT

An apparatus can include a connection manager adapter that is configured to maintain presence for each of the plurality of non-IP endpoints in an IP messaging and presence protocol based on the endpoint presence data. The endpoint presence data includes a unique identifier and attribute data received for each of a plurality of non-internet protocol (IP) endpoints. The connection manager adapter can be configured to access the endpoint presence data and convert a message between the IP messaging and presence protocol and different protocol for communication with a given non-IP endpoint of the plurality of endpoints.

### TECHNICAL FIELD

This disclosure relates generally to controlling distribution and routing from a messaging protocol.

### BACKGROUND

In various types of network infrastructures, different types of routing schemes (e.g., unicasting, multicasting, broadcasting) can be utilized for delivery of messages and may be useful in different circumstances. However, some communications protocols may be unable to efficiently utilize certain types of routing schemes. The use of different types of communications casting can become further complicated when a message is communicated across systems using multiple communication protocols, such as may be required for new devices and existing (e.g., legacy) devices that may be incapable of leveraging certain newer messaging protocols.

### BRIEF DESCRIPTION OF THE DRAWINGS

FIG. 1 depicts an example of a mapping system.

FIG. 2 depicts an example of a communication system communicating messages in a messaging protocol.

FIG. 3 depicts an example of a cable system that can implement a mapping system in a messaging protocol.

FIG. 4 is a flow diagram depicting an example of a method for mapping messages.

FIG. 5 is a flow diagram depicting another example of a method for mapping messages.

### DESCRIPTION OF EXAMPLE EMBODIMENTS

### Overview

This disclosure relates generally to controlling distribution and routing from a messaging protocol, such as an Internet Protocol (IP) based messaging and presence protocol.

In some examples a mapping system can be configured with logic that processes messages provided to one or more services according to a messaging protocol. The message can include a service address that identifies one of the services in the messaging protocol. The service address can also include a mask that is utilized by the mapping system to control how the message will be distributed to one or more recipient nodes. For example, the mask can be applied to control provisioning of a message to multiple recipient nodes (e.g., corresponding to masking cast). The mask can also be applied to control provisioning of a message to one or more endpoint devices via respective control nodes (e.g., corresponding to host casting).

As an example, the mapping system can provide a proxy interface to address routing of messages to and/or from traditional controllers using the existing interfaces on such traditional controllers. As a further example, the message can be delivered to one or more recipient nodes, as determined by the mapping system, using a service interface that is selected according to a service identifier in the service address of the message. The recipient node (e.g., a controller of a hybrid fiber coaxial (HFC) cable access network) can further control distribution of the message. For example, each recipient node can include distribution mapping data that specifies a type of distribution (e.g., unicast, multicast or broadcast) based on the mask that is provided in the message. In other examples, the recipient can be a final endpoint of the message, which can also be determined based on the mask and the mapping data.

### Example Embodiments

FIG. 1 depicts an example of a mapping system 10. The mapping system 10 provides a mechanism to enable an internet protocol (IP)-based messaging protocol to be utilized for routing and delivery of various messages efficiently through existing service interfaces utilized by nodes coupled to the mapping system. Such existing service interfaces can employ non-IP based protocols, IP-based protocols or a combination of non-IP and IP-based protocols, including proprietary and/or standards based communication protocols. The mapping system 10 can be implemented in a computer system and may implement instructions stored in a non-transitory computer readable medium that are executable by a processor (e.g., including one or more processor cores). For example, the mapping system 10 can be implemented in a router or other device that is configured to implement the functions disclosed herein.

The mapping system can reside in a service domain that is addressable according to a messaging and presence protocol. As used herein, the messaging and presence protocol provides a technology infrastructure that provides for the asynchronous, end-to-end exchange of structured data by means of direct, persistent information (e.g., XML) streams among a distributed network of globally addressable, presence-aware clients (e.g., endpoints) and services. IP messaging and presence protocols operate in the application layer of the OSI model. The application layer provides for communications protocols, including the IP messaging and presence protocols, for process-to-process communications across an IP computer network. As such, the messaging and presence protocols employ underlying transport layer protocols to enable various connections.

Examples of messaging and presence protocols that can be utilized by the mapping system 10 include the extensible messaging and presence protocol (XMPP), such as defined by the internet engineer task force under Worker's Specifications RFC 6120 RFC 6121, RFC 6122, and RFC 3923. Other IP-based message-oriented application level middleware and protocols can be utilized by the mapping system 10 (e.g., the advanced message queuing protocol (AMQP)).

The mapping system 10 thus can operate as a proxy in a messaging and presence protocol and provide service translation, routing and distribution of messages based on a service address of a given message. As an example, in addition to the service address (e.g., a well formed Jabber construct) operating to deliver a message to a service domain that is supported by the mapping system 10 according to a corresponding messaging protocol, the same service address can also include data that provides for translation, routing and delivery of the message by the mapping system to one or more recipient nodes. Each recipient node can be a device, a service or application, which is capable of receiving and/or sending messages. In some examples, the recipient node can be a control system or a service associated with operation of a control system for a hybrid fiber coaxial (HFC) cable access network, such as can reside at a headend or other location.

In the example of FIG. 1, a messaging interface 12 can receive a given message that is addressed to a service in a respective service domain of the messaging and presence protocol. In some examples, the messaging interface 12 can be capable of receiving messages for any number of one or more services in a given domain supported by the mapping system 10. Presence information for each service thus can be advertised (e.g., by the messaging interface) as respective services via a service directory implemented in the messaging and presence protocol through which the messages can be sent. The mapping system thus operates as the proxy for receiving messages addressed to each respective service in the domain. The messaging interface 12 can also be configured to communicate messages from the mapping system 10 to the messaging protocol such as to one or more end points in the same or different domains. As an example, a given domain can be associated with a router or other topological components that may exist in the application layer (e.g., layer 7) where the messaging protocol operates. As mentioned above, the application layer protocol thus can be implemented as a messaging and presence protocol, such as XMPP or the like.

The mapping system 10 can include logic 14 that is configured to process a message that is received by the message interface 12 (e.g., for a supported service address) and distribute the message to one or more recipient nodes based on the service address in the message and mapping data 16. The service address in a given message can include a service identifier and a mask. The service identifier, for example, can identify both a unique service that includes a respective service interface 18 that is configured to communicate over an existing protocol with one or more endpoint nodes. For example, a service address may be implemented as a well formed construct in the messaging and presence protocol, such as follows:

SERVICE_ID@domain/mask
where the SERVICE_ID is a unique identifier, such as an address or the like, for a service that can operate as an endpoint in the messaging and presence protocol;
“domain” is a prescribed domain in the messaging and presence protocol in which one or more endpoints reside; and
“mask” is a value that is used to control routing and distribution of the message to one or more recipients and the mode of delivery to such recipients.

In some examples, the service interface can provide for communication of command, control and/or provisioning messages to one or more control systems in a HFC cable access network (also referred to as a cable television system). One or more such control systems can be legacy systems that are incapable of communicating command, control and/or provisioning instructions via the messaging and presence protocol; and the mapping system 10 thus can operate as a proxy for distributing and routing service messages selectively to the control systems. The services messages can be provided by control plane services for the CATV system, which may or may not be configured to communicate via the messaging and presence protocol. The control system can consume the message internally, such as for configuring the control system based on the command, control and/or provisioning instructions in the message. Alternatively, the control system can control distribution of the message to one or more endpoint devices (e.g., customer premises equipment) for configuring the endpoint device(s) based on the command, control and/or provisioning instructions in the message.

In the example of FIG. 1, the logic 14 includes a mapping agent 20 and a distribution control 22. The mapping agent 20 is configured to determine at least one recipient node (e.g., a downstream control system) for the given message based on applying the mask to predetermined mapping data 16. The mapping data 16 can include a data structure representing a list of recipient nodes for each service that is supported by the mapping system 10. For example, the mapping data 16 can specify recipient metadata for a set of recipient nodes and their respective identifiers (e.g., controller IDs) for each of the nodes supported. The mapping agent 20 thus can utilize a respective service identifier in the service address of a given message to select which set of recipient nodes are potential recipients, and the mask can be applied to the corresponding metadata to determine destination nodes for the given message.

As a further example, the mapping agent 20 can include an address calculator 24 that is configured to compute an address (e.g., a network address) for each recipient based on applying the mask to each respective address of recipient nodes in the corresponding list that has been selected from the mapping data (e.g., by the mapping agent) based on the service identifier. For example, where a message includes a service identifier for a given service, the address calculator 24 can apply the mask to each recipient node that is associated with such given service to compute a corresponding network address for the node (e.g., a predefined node ID).

As a further example, the mapping agent 20 can convert the mask to a binary representation that includes a predetermined number of bits that is commensurate with a binary representation of the node address. In some examples, the mask and node addresses can each be four bites long such that they can be easily mapped to the notion of IP addresses and subnet masking to facilitate assignment of the systems with ID's based on routing and distribution needs of the system. It is to be understood, however, that other forms of masking and identifiers can be utilized in other operations than bitwise operations may be utilized to perform the respective functions associated with routing and delivery of the messages.

The address calculator 24 can perform a bitwise operation between the bits corresponding to the mask relative to a corresponding binary representation of the addresses for each of the recipient nodes associated with the respective service. For example, the bitwise operation can correspond to a bitwise ANDing between the mask and the node address stored in the mapping data 16 for each of the recipient nodes for the identified service. The address calculator 24 thus can provide a computed address that can correspond to one or more recipient nodes to which the message can be distributed via the corresponding service interface 18. There can be any number of service interfaces 18 to support communication with each respective service that is supported by the mapping system.

In addition to the application of the mask specifying which one or more recipient nodes the message is to be distributed, the mask can also control subsequent distribution of the message by the recipient node. For example, the mapping agent 20 can include a matching function 26 that is configured to determine a mode of delivery for the message to each identified recipient node. The matching function 26 can determine the mode of delivery based on the mask and the computed address for the recipient. For example, the matching function 26 can implement logic to determine whether a match exists based upon applying the mask to the address computed by the address calculator, such as in a bitwise operation.

As an example, the matching function 26 can determine, based upon the bitwise operation, whether the message is to be delivered to a single recipient node, multicast to a proper subset of two or more recipient nodes or if the message is to be broadcast to each of the recipient nodes via the service interface 18. As a further example, the matching function 26 can determine that the mode of delivery for the message is unicast delivery to a single node in response to determining an exact match based on the mask and the address that is computed by the address calculator 24. As another example, the matching function can be configured to provide the message via the service interface 18 for delivery to a group of nodes in response to computing a match based on applying the mask to the computed address for each of the nodes in the respective group. In some examples, the group of nodes can correspond to a service delivery region (e.g., one or more hubs or other downstream plant region). In other examples, the group can correspond to a proper subset of nodes (e.g., control systems). Thus, the mask can be configured by the sender of the message (e.g., a control plane service) to control routing and delivery of the message to recipient nodes for each corresponding service that is supported by the service interface 18.

The distribution control 22 is configured to process the message and provide the process message to a respective service interface 18 based on the service identifier in the service address of the incoming message. The distribution control 22 can include message translation function 28, a service agent 30, and a protocol adapter 32. The service agent 30 is configured to select a given service interface that is utilized for delivering the message to each recipient based on the service identifier in the message's service address. As mentioned above, there can be one or more recipient nodes to which the message is to be routed, and thus the service agent 30 can select appropriate service interfaces to enable communication of the message from the mapping system 10 to each recipient node. For example, in certain systems (e.g., CATV distribution plants), different control systems may implement different communication protocols for a given service. Thus the service agent 30 can select the appropriate service interface to enable communication of the service message to each respective recipient node.

The translation function 28 of the distribution control 22 can be implemented as machine executable instructions stored in memory in such a manner as can be executed by a processor. The translation function 28 can be configured to process a message received via a messaging and presence protocol and prepare the relevant content in the message for delivery to a given endpoint based on the service identifier in the service address. The translation can be from an IP-based protocol to a non-IP communications protocol that is utilized by the recipient node, for example. Since the message includes the service identifier, as part of the service address construct, in some examples, the translation function 28 can control routing of the message directly from the service identifier in the message without explicit look up in memory. The translation function 28 can re-format the message for delivery to one or more recipient nodes determined by the mapping agent 20. The translation function 28 can perform the conversion of messages based on the mapping data 16 that is stored in memory. Alternatively, the translation function 28 can generate instructions identifying communication parameters to implement the delivery to the endpoint node(s) based on the service identifier and mapping data 16. The translation function 28 can also embed the initial SERVICE_ID/mask in the communication parameter.

The distribution control 22 can also include a protocol adapter 32 configured to convert the message to given protocol for communication to the recipient node(s) based on the converted message and instructions from the translation function 28. For instance, the translation function 28 can provide a converted message (e.g., according to an XML schema) that specifies each recipient node (e.g., a network address), other instructions (e.g., command) and protocol requirements. The protocol adapter 32 can thus be programmed to repackage the message from the IP messaging and presence protocol for transmission to a given non-IP endpoint according to protocol requirements of each recipient node (e.g., an application layer protocol that is implemented by a control system).

As an example, the protocol adapter function 32 can be configured to repackage the message according to the business and operations support system (BOSS) interface, which was developed by Scientific-Atlanta, Inc. Other protocols can be used, which will vary according to application requirements and capabilities of the resource nodes to which the message is sent. Examples of some other protocols in the context of a HFC cable access network can include a broadcast file system (BFS) API, a pass through API (PTAPI), loadPIMS or the like. The protocol adapter 32 can adapt the message for communication according to other application layer interfaces. The protocol adaption function 32 can also be utilized for adapting communication transaction requests and responses between the mapping system 10 and the IP messaging and presence layer. Additionally, the protocol adaption function 32 can be configured to implement multiple protocols such as to support communication with a plurality of different devices that might employ different protocols. For example, a given mapping system 10 can be configured to support a digital access controller, a digital network control system (e.g., from Cisco Systems, Inc.) as well as control systems from other manufacturers.

In view of the foregoing, it is to be understood and appreciated that the mapping agent, including the address calculator 24 and matching function 26, can effectively operate as a filter, which employs the service address for controlling delivery of the message to a selected recipient node or multiple recipient nodes based on applying the mask to node information (e.g., node addresses) stored in the mapping data 16. The mapping system can thus operate as a proxy for any number of services to enable the translation, routing and distribution of messages from services via a newer protocol that is not supported by all recipient nodes. In this way, a provider can continue to utilize legacy distribution and endpoint devices while certain communication protocols are upgraded in other parts of the system. Moreover, the upgrades can be modular since the mapping system 10 is scalable to support such changes in a distributed manner. Efficiencies in communications can also be achieved since, for example, the mapping system enables a single message to be translated into multiple messages for multiple client endpoints, rather than sending individual messages to the client endpoints.

FIG. 2 depicts an example of a system 100 that can be utilized for sending messages for distribution delivery by a mapping system (e.g., a mapping system 10 of FIG. 1). In the example of FIG. 2, the system 10 includes a service 102 that is configured for providing a message via an IP-based messaging and presence protocol and which can be processed by a mapping system for delivery to one or more recipient nodes. The mode of delivery (e.g., message casting) will be specified and assigned by the service 102, and it can vary according to the type of service or content of the message.

In some examples, the service 102 can correspond to a control plane or a management service that is implemented in or controlled by a provider of a CATV distribution system and the recipient node(s) can be one or more control systems in a head end, one or more hubs and/or one or more customer premises equipment (CPE). Examples of the service 102 can include a billing system, firmware management services, channel map management services or the like. Thus, in some examples, the service 102 can be programmed to send a message; to a given control system downstream in a cable distribution plant, to one or more control systems or broadcast to all control systems. The service 102 can be activated to provide the command or control instructions in the message in response to a user input or in response to a call to an application that is associated with the service 102.

In other examples, the service 102 can send a given message to a given control system for distribution to one or more further downstream devices, such as CPE or to a designated group of CPEs (e.g., a hub). As an example, a billing system can be programmed to send billing information to a given CPE in response to a user ordering a pay per view (PPV) program. In other examples, a group of CPEs, corresponding to different customers within a hub of a cable distribution plant, may be sent updates or status information associated with a channel map unique to the area in which the CPEs reside. In other examples, the service 102 can provide an upgrade message (e.g., containing firmware updates) to CPE equipment, which can be all CPEs in the cable system or a selected subset of CPEs. Thus, the identification of CPEs and control systems of the cable distribution plant can be specified by the service 102 for constructing the service address of the message which includes a service identifier and a mask that are utilized for controlling delivery and routing of the message by a corresponding mapping system. However, the service and/or the recipient node(s) may not be configured to send or receive the message via a messaging and presence protocol. If the service 102 cannot directly employ the messaging and presence protocol, the service 102 can utilize a protocol adapter 104 that is configured to enable the service 102 to access a service translation function 106. In other examples, the service translation function 106 can be implemented as part of the service or the service can access the service translation function directly without the protocol adapter.

In the example of FIG. 2, the service translation function 106 is configured to construct a message in response to the request from the service 102. The message can include a message body, which can include command and control instructions, as well as a service address. The service address can include a service identifier, which uniquely identifies a service in a given service domain, and a corresponding mask, such as disclosed herein (e.g., SERVICE_ID@domain/mask).

The service translation function 106 thus can be configured for communication over a messaging protocol fabric, such as may implement an IP-based presence and messaging protocol (e.g., XMPP). Thus the service translation function 106 can include a messaging interface 108 that is configured to provide for a transmission and receipt of messages via the messaging fabric. The service translation function 106 can also include a service mapping function 110 that is configured to map the request to a corresponding service of an associated service domain based upon mapping data that may be contained in a mapping database 112. The mapping database 112 can be implemented as a computer readable medium that may be local relative to the service translation function 106 or may be distributed across a network in one or more memory structures. The service mapping function 110 employs the associated data in the mapping database to determine a mode of delivery and service to which the corresponding message is to be sent.

As a further example, the service translation function 106 can include a mask generator 114 configured to determine a mask for the message. The mask has a value designed to enable delivery of the message to one or more intended recipient nodes. The mask can further be utilized to determine a mode of delivery (e.g., unicast, multicast or broadcast) to communicate the message to one or more intended recipient nodes. For example, the mask can include a mask value (e.g., in a hexadecimal) that can be converted to a binary representation of an address that can be applied to node addresses associated with a given service and service domain to compute an identity of each recipient node and specify a predetermined mode of delivery for the message. In some examples, the mask can also include an identification that maps to further downstream delivery from the recipient node to one or more devices (e.g., CPEs). The one or more devices can include a specific device downstream from the control system, a group of devices (e.g., a logical service region that includes multiple devices), such as a hub of a cable distribution plant or specify a broadcast to all devices downstream from a recipient node. Thus each recipient node can be programmed with a data structure (e.g., look-up table) that specifies delivery mode for different mask values. The mask generator 114 thus constructs the mask according to the requirements in the instructions from the service 102 based on the mapping data in the mapping database 112. The mapping database 112 contains information, such as in the form of a look-up table, to enable the mask generator to construct the appropriate mask for delivery of the message to each of the intended recipients.

The service mapping function 110 combines the service identifier and domain information with the mask to provide a corresponding service address for the message that is to be sent. In some cases, the service translation function 106 may generate multiple messages in the event that a single message is incapable of reaching each of the intended recipient nodes. A protocol translation function 116 can translate the message, including the service address, to the appropriate protocol for distribution and delivery via the messaging fabric. For example, the protocol translation function 116 can encapsulate command and control data into message payload with the service address provided as a header for delivery by the messaging interface 108 to a router 120 via the messaging and presence protocol. In some examples, the service 102 can be configured for native operation in the messaging and presence protocol and communicate directly with the domain 122. For instance, when the service is in the same domain as the router 120, the service 102 can connect to messaging and presence protocol fabric using a service connection manager (SCM) 128, which is configured to adapt service communications (e.g., service requests and response) to the messaging and presence protocol and vice versa. As another example, the SCM 128 may reside external to the domain 122, and it could communicate with the router 120 via a router-to-router protocol that encapsulates the application level messaging and presence protocol. For example, the service translation 106 may employ the messaging interface 108 to construct or deconstruct messages communicated with a specified service (e.g., in the S1.DOMAIN.COM).

The router 120 forms part of a domain 122 demonstrated in the example of FIG. 2 as R1.domain.com. The domain 122 can provide a hierarchical distributed naming system for devices, services or other resources to communicate via a transport layer. A system 100 can include any number of domains and services. Thus, each IP resource operating in the domain 122 can be provided a unique identity for communications within the domain according to the messaging and presence protocol. The router 120 can also employ a router-to-router (R2R) protocol for connecting to other routers in a network, such as an intranet, a wide area network (WAN) or a cloud-based infrastructure. The router-to-router (R2R) protocol thus encapsulates messages being communicated in the application level messaging and presence protocol.

The domain 122 can include one or more services (e.g., service 2) 124, which may be internal services of the domain or external services that connect via a connection manager, such as disclosed herein. The service 124, further, can connect to an external system (e.g., via an API) to access information and methods to provide service-related functions. The domain 122 can also include and one or more connection managers (CM) 126 configured to provide IP connectivity (e.g., using TCPI/IP) to one or more IP-based endpoints 130. Each connection manager 126, 128 may reside on the same virtual machine or on a separate machine from where the router 54 resides. For example, each of the IP-based endpoints 130 can be configured to operate in the IP messaging and presence protocol (e.g., XMPP) environment. The IP endpoint 130, for example, may connect to the connection manager 126 through an IP connection (e.g., TCP/IP) such as may be made via a modem or other type of network interface that provides a means for communicating via the IP messaging and presence protocol that is managed by the connection manager. For instance, each endpoint 130 can be configured to advertise its own presence via the IP messaging and presence protocol. Additionally, in the example system 100, the messaging and presence command and control layer of domain 122 can control each IP-based endpoint 130.

As mentioned above, the message provided by the service 102 can be sent to an identified service, which resides in a service domain device 134. The service domain device 134 includes a service mapping system 136 that is configured to support any number of one or more services for translation, routing and distribution of a given message to one or more recipient nodes based on a service address in the message and service mapping data 138, as disclosed herein. In some examples, the service domain of device 134 can be a separate domain from the R.DOMAIN.COM domain 122, and can communicate with the domain 122 via router-to-router protocol or a server-to-server-protocol. In other examples, the service domain of device 134 can reside within the R1.DOMAIN.COM domain 122, and connect to a service connection manager (e.g., SCM 128) operating in the messaging protocol. The service mapping system 136 can thus provide a service domain proxy for each such service in a given service domain, which in this example is demonstrated as S2.DOMAIN.COM. The service mapping system 136 can be configured according to the example of system 10 disclosed with respect to FIG. 1.

As mentioned, the device 134 can itself include a router (not shown) and communicate with the messaging and protocol fabric to another domain 122 such as using a router-to-router protocol. In other examples, the device 134 can operate as a connection manager and communicate directly with the messaging protocol fabric. For instance, the service domain device 134 can include a presence manager 142 that is configured to perform an advertisement function to register and advertise each of the services in the domain via corresponding service directory that is implemented in the messaging protocol fabric. Each service or device implemented in the domain can communicate with other endpoints registered in the messaging and presence protocol. As disclosed with respect to FIG. 2, the unique identifiers for each of the services supported in the domain can include a corresponding service ID and mask, which can be set in response to a service request by the service 102 (e.g., a control plane service) to provide for translation, routing and distribution to one or more recipient nodes by the device 134.

The service mapping system 136 can employ a service identifier to uniquely identify one or more control system interfaces 144. The interfaces 144, for example, can support functionalities that can vary according to the services 102 or 124 that are communicating the messages and the appropriate functionalities of the respective recipient nodes. Examples of some control system interfaces 144 in the context of a CATV system can include BOSS, PTAPI, BFS API, LOAD PIMS, SFTP or the like. The service mapping system 136 further can perform translation and distribution of the message to the appropriate interface 144 for communication of the message downstream. As mentioned above, the service mapping data 138 can include metadata that identifies each of the control systems or other types of recipient nodes to which the message can be communicated. The device 134 can also include a network interface 140 to provide for communication with a network via which the messaging protocol fabric can be communicated. The network interface, for example can implement a lower level protocol, such as TCP/IP or the like, on which the application level messaging and presence protocol fabric may be implemented. The use of a service mapping system thus enables each of the services 102 or 124 to ubiquitously use the same messaging mechanism via the IP messaging and presence protocol (e.g., XMPP) to implement command and control for both IP-based endpoints 130 and non-IP based endpoints (not shown). Hence, translation from the IP messaging presence and protocol to the protocol-adapted message for delivery to the non-IP endpoints can be facilitated.

FIG. 3 depicts an example of part of a cable television system 200 that can implement message routing and delivery using a service mapping system 202 to provide for translation, routing and distribution of messages. The system 200 employs a messaging and presence protocol (e.g., XMPP) to communicate messages in an application layer of the system. Control plane services 204 can communicate with the service mapping system 202 via a messaging protocol fabric 206. In the example of FIG. 3, the control plane services are demonstrated as including a billing system 208, a firmware management service 210 and a channel map management service 212. It is understood that these are examples of some possible services and other services may be implemented in addition to or as an alternative of the services depicted in this example.

Each of the services 208, 210 and 212 can communicate with any endpoint that is registered with the messaging protocol fabric 206 including the service mapping system 202, for which registration and related advertisement information can be maintained in a service directory of the protocol. The service mapping system 202 can be implemented in a computing device 214 in order to provide a service domain proxy, which in this example is demonstrated as S2.domain.com. The device 214 can itself be a router and communicate with another domain 216 in the messaging and protocol fabric 206 such as using a R2R protocol. Additionally or alternatively, the device 214 can operate as a connection manager and communicate directly with the messaging protocol fabric 206, demonstrated as connection 221.

The domain 216 can also include one or more services, a router and a connection manager 218. The connection manager 218, for example, can connect one or more IP-based endpoint devices with the messaging protocol fabric 206. The control plane service or other endpoints within the messaging protocol fabric can communicate with any advertised endpoints in the fabric, including the IP-based endpoints and the services supported by the mapping system 202 of the device 214. The device 214 can also include a network interface 234 to provide for communication with a network via the messaging protocol fabric. The network interface 234, for example can implement a lower level protocol such as TCP/IP or the like on which the application level messaging protocol fabric 206 can be implemented.

As an example, the control plane services 204 can be programmed for explicit communication in the messaging and protocol fabric 206, such as programmed to implement XMPP messaging. In other examples, one or more of the control plane services 208, 210 or 212 can connect to the messaging protocol fabric 206 via a services connection manager (not shown). Each of the services 208, 210 and 212, for example, can utilize a service translation function, such as the function 106 disclosed with respect to FIG. 2. In order for a given one of the services 208, 210, 212 to communicate messages to one or more recipient nodes in the system 200 via the messaging protocol fabric 206, such a service would need to identify each such recipient, such as according to a MAC address or IP address or other unique identifier in the system. The service function (e.g., function 106 of FIG. 2) would generate a unique service address for an appropriate service operating in the S2.domain.com and a mask to enable the service mapping system of the device 214 to implement the appropriate translation, routing and distribution of the message, as disclosed herein.

By way of example, the device 214 can include a presence manager 222 that is programmed to perform an advertisement function to advertise and register each of the services that it supports in the service domain via corresponding service directory for the messaging protocol fabric 206. As disclosed with respect to FIG. 2, unique identifiers for each of the services and corresponding recipient nodes in the system 200 can be encoded by a corresponding service ID and mask (e.g., by service translation function 106 of FIG. 2) in response to a request from each of the control plane services 204. Additionally, the mask of a corresponding message that is provided by one of the control plane services can also be utilized by the service mapping system 202 to determine a mode of delivery for the service message to downstream nodes.

For example, the downstream nodes can include one or more control systems 224 and 225 demonstrated as control system 1 through control system M, where M is positive integer denoting the number of control systems. The control systems 224 and 225 can be implemented in respective headends of the system 200. Additionally or alternatively, the recipient nodes can correspond to endpoint devices 226 and 228 associated with each of the respective control systems 224. In the example of FIG. 3, control system 1 is coupled to communicate with N endpoint devices 226 and control system M can communicate with P endpoint devices, where N and P are positive integers denoting the number of devices associated with each respective control system.

The endpoint devices can be non-IP endpoint devices. As used herein, a non-IP endpoint device refers to a device that is not configured to communicate via the IP messaging and presence protocol. Examples of non-IP endpoint devices include set-top boxes, cable cards, other consumer premises equipment or the like device that implement non-IP messaging protocols. These non-IP endpoint devices are sometimes referred to as legacy devices as they do not encompass newer types of endpoints that are IP-enabled and, in particular, enabled for operation in an IP messaging and presence protocol environment. Instead, such non-IP endpoints communicate using legacy protocols, such as RF based communication (e.g., quadrature amplitude modulation (QAM) or quadrature phase-shift keying (QPSK)) that may encode command and control information (e.g., according to ISO/IEC 13818-6).

Each control system 224 and 225 can be coupled to respective endpoint devices 226 and 228 through a combiner network 230 and 232. The combiner networks 230 and 232 can combine service messages (e.g., from the control plane services 204) with other broadcast content that can be sent to the non-IP endpoints 226 and 228 via RF modulation (e.g., QAM, QPSK or the like). Thus, while the message content can be broadcast via the combiner network 230 and/or 232 and be seen by each non-IP endpoint 226 and 228, only the non-IP endpoint(s) to which the service message was originally addressed will extract the message content and perform the encoded instructions.

In some examples, the endpoint devices 226 and 228 can be implemented as CPE, such as legacy set top boxes, cable cards or the like that may communicate command and control data with the control systems 224 and 225, respectively, via RF modulated signals. In other examples, some of the endpoint devices 226 and 228 can be implemented as hubs (e.g., distribution equipment) connected to communicate with downstream CPE's. The device 214 can include control system interfaces 242 and 244 for communication between the device and with each control system 224 and 225.

Each control system 224 and 225 can selectively control distribution of a given service message to one or more respective endpoints 226 and 228 based on the mask in the given message and endpoint mapping data 236 and 238 stored (e.g., in memory) on each control system. For example, the service mapping system 202 can route each service message to one or more control systems based on applying a mask to controller identifying data contained within the service mapping data 240. The service mapping system 202 can employ a corresponding control system interface 242 or 244, according to the service identifier in the service address of the message. This interface can then be used for routing the command and control information to one or more control systems that have been identified. That is, the command and control information can be sent according to a given service interface that is selected based on the service ID of the message's service address. The control system interfaces 242 and 244, for example, can support functionalities that can vary according to the services that are communicating the messages and the appropriate functionalities of the respective control systems 224 and 225. Examples of control system interfaces 242 and 244 can include BOSS, PTAPI, BFS API, LOAD PIMS, SFTP or the like, and the device 214 can support any number and type of such interfaces.

By way of example, the billing system 208 can prepare and send a message via the messaging protocol fabric 206 to one or more intended recipient nodes in a service domain, such as the S2.domain.com domain associated with the device 214. The IP service address can be constructed for delivery of the message to each one or more intended recipients. For instance, the service address can include a service identifier to uniquely identify a given service interface 242 or 244, which can correspond to the control plane service (e.g., billing) that sent the message. The service address can also include a mask that can be utilized to control appropriate translation and routing and distribution of the message based on applying the mask to service mapping data 240 for the specified service.

The message can be routed to the device 214 based on the service address in the messaging and presence protocol fabric 206. The service mapping system 202 can employ service mapping data 240 to compute an address for each endpoint based on the mask contained in the service address as well as a matching function to compute a mode of delivery for the message to each recipient node identified by the address that is computed. The service mapping system 202 further can perform translation and distribution of the message to the appropriate interface 242 or 244 for communication of the message downstream to one or more control systems 224 and 225. As mentioned above, the service mapping data 240 can include metadata that identifies each of the control systems and other endpoints to which the message can be communicated by the device 214 as well as service interfaces 242 and 244 based on the service identifier.

After the control system(s) and mode of delivery have been computed, the message can be translated and communicated via a service interface which employs the appropriate protocols necessary for the successful communication of the message to each of the target control systems 224 that have been identified by the service mapping system 202 as recipient nodes. Each of the control systems 224 and 225 can include endpoint mapping functions 236 and 238 that can control delivery of the message according to the selected delivery mode. As disclosed herein, the delivery mode can be computed based on the mask and the mapping data such as to indicate a unicast address to a given control system 224, a hostcast address to a selected endpoint 226 or 228 or a multicast distribution to a selected group of endpoints 226-228. As an example, a group of endpoints can correspond to a hub that can communicate with a plurality of respective endpoints as disclosed herein.

In view of the foregoing structural and functional features described above, an example method will be better appreciated with reference to FIG. 4. While, for purposes of simplicity of explanation, the method is shown and described as executing serially, it is to be understood and appreciated that such method is not limited by the illustrated order, as parts of the method could occur in different orders and/or concurrently from that shown and described herein. Such method or portions thereof can be implemented as instructions stored in a non-transitory storage media as well as be executed by a processor of a computer, for example.

FIG. 4 depicts an example of a method 300 that can be utilized (e.g., by a mapping system) for controlling routing and distribution of a message. The method begins at 302 in which a message is received. The message can include a service address such as a well formed address construct for routing in a messaging and presence protocol, as disclosed herein.

At 304, a determination is made as to whether a service ID specified in the service address of the message is configured for further processing. That is, does the service ID correspond to valid service supported by the mapping system? If the service ID is not configured, the method proceeds to 306 to respond with an error and the method can end. If the service ID specified in the address is configured, the method can proceed to 308. At 308, a determination is made as to whether a mask in the service address matches one or more controller IDs. For example, the mask can match a given one of the controller IDs exactly or it can match multiple controller IDs. If the mask matches one or more controller IDs, the method can proceed to 310 for translating the message and forwarding it to each identified controller for which the match was found. The match can be determined as disclosed herein based on applying the mask to the controller ID for each controller that is identified for the service determined at 304. The translated message can be best routed to a given controller in the system based on application of the mask to the controller identified such as stored in the associated mapping data.

If the mask does not match at 308, the method can proceed to 312. At 312, a determination is made as to whether the mask matches a host identifier on a controller's network. If the mask matches a host identifier provided on a given controller's network, the method can proceed to 314 in which the message is translated and forwarded to the identified host via the specified controller. For example, the host can correspond to a downstream endpoint device, such as a CPE or the like.

If the determination at 316 is negative, the method can proceed to 320 for another determination. The determination at 320 evaluates and applies the mask to each controller ID to determine if a match exists between the mask and all the downstream controller nodes. For example a mask can be established such that application of the mask (e.g., the bitwise operation) results in identifying each controller that may reside downstream from the mapping system implementing the method. If such a broadcast match exists, the method proceeds to 322 and the message can be translated and forwarded to each of the controllers, thereby effecting a broadcast distribution to such controllers.

Each controller that receives the translated message can further analyze the mask that is provided in the message relative to a predetermined data structure (e.g., endpoint mapping data 236 and 238). The data structure can be applied to the mask for determining distribution of each respective service message based on matching mask values to different broadcast service groups specified in the data structure. For example, broadcast service groups can correspond to groups of endpoints residing downstream from the controller. The data structure can provide a table (e.g., a look-up table) programmed to determine downstream distribution of message content in response to the mask that was specified in the message received by the mapping system. In some examples, the message can include a mask that results in its broadcast to all broadcast service groups such that the message will be distributed to each and every endpoint downstream from the controller. It is to be understood that a broadcast service group can include one or more specified downstream nodes, which can include endpoints or groups of endpoints. In other examples, the mask can contain a value that does not represent a further distribution from the control system to endpoints such that the controller itself will consume the message such as for implementing command and control instructions provided by a service or other endpoint in the messaging and presence protocol fabric.

FIG. 5 depicts an example of another method 400 that can be implemented. At 402, the method includes receiving a message at device (e.g., the mapping system 10 of FIG. 1, device 134 of FIG. 2 or device 214 of FIG. 3) via a messaging protocol based on a service address of the message. As disclosed herein the message includes a service address and a mask, which enable the message to be received at a message service of the device. There can be any number of such services that can receive messages via the messaging protocol.

At 404, the mask can be applied to mapping data to determine one or more recipient nodes for the message. The mapping data can specify a location for each of the plurality of nodes as well as specify service interfaces operative to provide the message to each of the plurality of nodes. For example, a network address for each of the plurality of nodes can be computed (e.g., by address calculator 24 of FIG. 1) based on applying the mask to respective identifiers stored in the mapping data for each of the plurality of nodes. A matching function (e.g., matching function 26 of FIG. 1) can also apply the mask to each computed network address to determine if a match exists and thereby control delivery of the message to the at least one recipient node.

At 406, a service interface can be selected for the message based on a service identifier in the service address. For example, a corresponding service interface may be provided for each service supported at the device for delivery of the messages sent to such service. At 408, the message can be sent to the at least one recipient node using the selected service interface.

In some examples, prior to sending the message to recipient nodes, the message can be translated (e.g., by translation function 28 of FIG. 1) to provide a translated version of the message for delivery to the at least one recipient node. Additionally, a protocol adapter (e.g., the adapter 32 of FIG. 1) can be configured to convert the translated message to a protocol-adapted message based on the mapping data. The protocol-adapted message thus can have a format to enable delivery to the at least one recipient node (e.g., an RF delivery protocol or the like) which can depend on the protocol utilized for communication with respect to each node.

As disclosed herein, in some examples, the recipient nodes for the message can be implemented as a plurality of controllers (e.g., control systems 224 and 224 of FIG. 3) in a cable television system. Each controller can service a plurality of downstream nodes (e.g., CPE or the like—nodes 226 and 228 of FIG. 3). Groups of selected downstream nodes can further be arranged into predetermined service groupings (e.g., broadcast service groups), such as can be physical or logical groupings of nodes. The mask thus can be programmable to identify each of the service groupings or at least a subset of the plurality of downstream nodes, such that distribution of the message to each of the controllers can be controlled according to the mask. The mask can be employed by each of the controllers to control further downstream distribution from each recipient controller to nodes located downstream relative to such controller(s).

### Examples of Mapping for Routing and Distribution of Messages

The following example will illustrate the service masks and addressing for routing and distribution of messages via an application level messaging protocol. This example uses 4 bytes for controller.id and as an illustration uses Class C IP address and Classless Inter-Domain Routing (CIDR) notation. It is understood that this is for purposes of an example, only and that, in practice, the controller.id can be any number of bytes, and a given recipient node can be different than a controller.

### Service Mapping Metadata

In this example each recipient node can be uniquely identified by a controller ID, which in this example is shown in both a dotted decimal value and a corresponding to a 32 bit word in a dotted octal format. Each controller ID can be stored in service mapping data (e.g., mapping data 16 of FIG. 1 or mapping data 240 of FIG. 3. In the following table it is assumed that there are four controllers for a given service (service S1) and that a 28 bit subnet mask, corresponding to 28 most-significant bits designed to identify one or more of the controllers based on applying a mask from a service address of a message as disclosed herein.

TABLE 1
Service Domain: example.com

| Svc | controller.id | controller.mask (/28) |
|---|---|---|
| S1 | 192.168.1.1 | 255.255.255.240 |
| | 11000000.10101000.00000001.00000001 | 11111111.11111111.11111111.11110000 |
| S1 | 192.168.1.17 | 255.255.255.240 |
| | 11000000.10101000.00000001.00010001 | 11111111.11111111.11111111.11110000 |
| S1 | 192.168.1.33 | 255.255.255.240 |
| | 11000000.10101000.00000001.00100001 | 11111111.11111111.11111111.11110000 |
| S1 | 192.168.1.65 | 255.255.255.240 |
| | 11000000.10101000.00000001.01000001 | 11111111.11111111.11111111.11110000 |

The metadata provided above in Table 1 can be translated into following addresses shown in Table 2, which include a controller ID using a CIDR notation, a network address for each controller. Also shown for each controller are a broadcast address (in dotted decimal and binary notations) and an IP range for a given subnet. In this example, it is assumed that each controller and associated subnets are part of a given service (e.g., service S1 from Table 1). The broadcast address can be one or more predetermined unique identifiers for each controller that specifies a mask value that is to be broadcast, for example. The IP subnet range can be used to specify different nodes in the subnet supported by each controller to which the message can be distributed based on a given mask provided in message's service address. Different unique masks can be assigned to different predetermined broadcast groups of nodes, such that each unique mask can be interpreted by a controller to effect routing to a specified broadcast group.

TABLE 2

| Controller using | Network | | IP range |
|---|---|---|---|
| CIDR notation | Address | Broadcast Address | in subnet |
| 192.168.1.1/28 | 192.168.1.0 | 192.168.1.15 | 192.168.1.1 |
| | | 11000000.10101000.00000001.00001111 | to |
| | | | 192.168.1.14 |
| 192.168.1.17/28 | 192.168.1.16 | 192.168.1.31 | 192.168.1.17 |
| | | 11000000.10101000.00000001.00011111 | to |
| | | | 192.168.1.30 |
| 192.168.1.33/28 | 192.168.1.32 | 192.168.1.47 | 192.168.1.33 |
| | | 11000000.10101000.00000001.00101111 | to |
| | | | 192.168.1.46 |
| 192.168.1.65/28 | 192.168.1.64 | 192.168.1.79 | 192.168.1.65 |
| | | 11000000.10101000.00000001.01001111 | to |
| | | | 192.168.1.78 |

In view of the example information in Tables 1 and 2, routing examples are provided below to demonstrate how a message having a service address can be routed to one or more controllers and interpreted by recipient controls for downstream distribution, as provided by the mask. In these examples, the service addresses are provided in the form SERVICE_ID@domain/mask, such a can be well formed address construct for a messaging and presence protocol (e.g., a JID for XMPP) as disclosed above.

### Example 1

service address: S1@example.com/192.168.1.1

This message will be routed only to the controller with a controller.id=192.168.1.1 because the mask 192.168.1.1 exactly matches the controller ID in table 2. This can be determined, for example, by bitwise ANDing the controller mask with the each controller ID for service S1 in Table 2.

### Example 2

This example further demonstrates how a given controller can interpret the mask in a message routed to it for distribution of the message to a specific part of the network. For example, the controller can be programmed to include endpoint mapping data (e.g., endpoint mapping data 236 and 238 of FIG. 3) programmed to map the mask into a corresponding one of a plurality of broadcast service groups, such as shown in Table 3. Each controller or other device can include a similar data structure for use interpreting a mask provided in a service address to effect distribution of the message to nodes belonging to an identified group.

TABLE 3
Controller CIDR = 192.168.1.1/28

| | Broadcast Service |
|---|---|
| Mask | Group (BSG) |
| 192.168.1.2 | BSG-1 |
| 192.168.1.3 | BSG-2 |
| 192.168.1.4 | BSG-3 |
| 192.168.1.5 | BSG-4 |
| 192.168.1.0 | All BSG |
| 192.168.1.15 | All BSG |
| 192.168.1.31 | All BSG |

In view of table 3, given a service address of S1@example.com/192.168.1.3 in a message, the message will be routed only to the controller with controller.id=192.168.1.1 based on applying the mask to the controller IDs of Table 2. The controller further is configured to map it to BSG-2 based on using the mask to evaluate endpoint mapping data of the controller (e.g., Table 3) in which the mask in the service matches the index value for BSG-2

### Example 3

This example illustrates sending multicast maskcast messages to a proper subset of controllers. Thus, given a service address S1@example.com/192.168.1.31, the mask value of 192.168.1.31 is converted to a binary representation (11000000.10101000.00000001.00101110) and applied (e.g., via bitwise operation by the mapping logic 14 of FIG. 1) to controller IDs stored in service mapping data associated with service identifier S1 (e.g., as provided in Table 2) to determine which (if any) controller IDs match the mask. In this case, the mask matches and will be routed to the controller with controller.id=192.168.1.1 and also to controller.id=192.168.1.17. The message is translated and forwarded to each of these controllers using the service interface corresponding to service identifier S1. Each of these controllers will identify that this is a broadcast message meant for all the BSG based on the value of the mask and forward it to all BSG.

### Example 4

A broadcast service message to all controllers can be sent (e.g., by a control plane service) using a mask that encompasses all controllers. In the example of the controllers of Table 2, a service address of S1@example.com/192.168.1.127 thus would be sent via a corresponding service interface to each of the controllers.

### Example 5

This example demonstrates how the messages can be sent to controllers having controller IDs 192.168.1.33 and 192.168.1.65, but not to the controllers having controller IDs 192.168.1.1 and 192.168.17. This can be accomplished for the example controller IDs of Table 2 by providing the message with a service address of S1@example.com/192.168.1.96. Since the mask does not correspond to a specified BSG in Table 2 for either controller, the controller can be configured to consume the message, such as by programming itself based on the content in the message payload, for example.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.

What is claimed is:

1. A non-transitory computer readable medium including instructions executable by a processor, the instructions comprising:
logic configured to process a service address of a message, the service address including a service identifier and a mask, the logic comprising:
a mapping agent configured to determine at least one recipient node for the message based on applying the mask to predetermined mapping data that includes a list of recipient nodes within an associated service domain identified based on the service identifier; and
a service agent to determine a service interface based on the service identifier in the message, the service interface being employed to send the message to the at least one recipient node.

2. The medium of claim 1, further comprising an address calculator configured to compute an address for the at least one recipient node in a network based on applying the mask to respective addresses for the list of recipient nodes within the associated service domain.

3. The medium of claim 2, wherein the mask is converted to a predetermined number of bits corresponding to the mask, the address calculator performing a bitwise operation between the bits corresponding to the mask relative to a binary representation of the addresses for the list of recipient nodes within the associated service domain to determine distribution parameters for delivering the message to the at least one recipient node.

4. The medium of claim 2, wherein the mapping agent further comprises a matching function configured to determine a mode of delivery for delivering the message to at least one recipient node based on the mask and computed address for at least one recipient node.

5. The medium of claim 4, wherein the mode of delivery comprises one of a unicast delivery to a single node, a multicast delivery to a plurality of N nodes, where N is a positive integer denoting a proper subset of all nodes, or a broadcast delivery to all nodes.

6. The medium of claim 5, wherein the matching function is configured to provide the message via the unicast delivery to a single node in response to determining an exact match based on the mask and the computed address for the single node computed by the address calculator.

7. The medium of claim 5, wherein the matching function is configured to provide the message via the multicast delivery to a group of nodes in response to determining a match based on the mask and the computed address for each of the nodes in the group of nodes.

8. The medium of claim 5, wherein the service address comprises a presence identifier configured to uniquely identify a service residing in a particular service domain within an internet protocol (IP) messaging and presence protocol.

9. The medium of claim 1, wherein the at least one recipient node for the message comprises a plurality of controllers in a cable network, each controller servicing a plurality of downstream nodes, groups of the downstream nodes being arranged into service groupings, the mask being programmable to identify each of the service groupings or at least a subset of the plurality of downstream nodes, and
wherein the logic further comprises distribution control configured to control distribution of the message to at least one of the plurality of controllers.

10. The medium of claim 9, wherein the distribution control comprises:
a message translation function configured to process the message into a translated message for delivery to the at least one recipient node based on the service identifier in the message and based on the mapping data; and
a protocol adaptor configured to convert the translated message from the message translation function to a protocol-adapted message based on the mapping data, the protocol-adapted message having a format to enable delivery to the at least one recipient node.

11. The medium of claim 1, wherein the service identifier comprises a qualified identifier that uniquely identifies one of a plurality of services in the service domain according to an internet protocol messaging and presence protocol, each service identifier comprising:
a unique identifier for a service in a given domain that is associated with a respective service interface; and
a domain identifier specifying a domain in the internet protocol messaging and presence protocol.

12. The medium of claim 11, wherein the service interface is configured to provide the message to the at least one recipient node as a protocol-adapted message communicated according to a different protocol than the internet protocol messaging and presence protocol used to receive the message, the message provided to the at least one recipient node including the mask to specify further distribution requirements for the message.

13. An apparatus comprising:
mapping data stored in memory, the mapping data specifying each of a plurality of nodes and each of at least one service to which each of the plurality of nodes is associated;
logic configured to receive a message according to a messaging protocol, the message including a service address that includes a service identifier, a domain identifier and a mask, the logic being configured to apply the mask of the message to determine at least one recipient node of the plurality of nodes to which the message is to be communicated, the logic also being configured to communicate the message to a recipient node via a corresponding service interface selected according to the service identifier.

14. The apparatus of claim 13, wherein the logic further comprises:
an address calculator configured to compute a network address for the at least one recipient node based on applying the mask to respective identifiers stored in the mapping data for each of the plurality of nodes based on the service identifier; and
a matching function configured to control delivery of the message to the at least one recipient node based on the mask and the network address computed for the at least one recipient node.

15. The apparatus of claim 14, wherein the logic further comprises
a service agent configured to select the service interface for each of the at least one recipient node based on the service identifier;
a message translator configured to provide a translated version of the message for delivery to the at least one recipient node; and
a protocol adaptor configured to convert the translated message provided by the message translator to a protocol-adapted message based on the mapping data, the protocol-adapted message having a format to enable delivery to the at least one recipient node.

16. The apparatus of claim 13, wherein the at least one recipient node for the message comprises a plurality of controllers in a cable access network,
wherein the logic further comprises distribution control configured to control distribution of the message to at least one of the plurality of controllers.

17. A method comprising:
receiving a message at a device via a messaging protocol based on a service address of the message, the message including the service address and a mask;
applying the mask to mapping data to determine at least one recipient node of a plurality of nodes, the mapping data specifying a location for each of the plurality of nodes and specifying service interfaces operative to provide the message to each of the plurality of nodes;
selecting a service interface based on a service identifier of the service address; and
sending the message to the at least one recipient node using the selected service interface.

18. The method of claim 17, wherein applying the mask further comprises:
computing a network address for each of the plurality of nodes based on applying the mask to respective identifiers stored in the mapping data for each of the plurality of nodes;
applying the mask to each computed network address to control delivery of the message to the at least one recipient node;
translating the message to provide a translated version of the message for delivery to the at least one recipient node; and
converting the translated message to a protocol-adapted message based on the mapping data, the protocol-adapted message having a format to enable delivery to the at least one recipient node.

19. The method of claim 17, wherein the at least one recipient node for the message comprises a plurality of controllers in a cable network, each controller servicing a plurality of downstream nodes, groups of selected downstream nodes being arranged into predetermined service groupings, the mask being programmable to identify each of the service groupings or at least a subset of the plurality of downstream nodes, the method further comprising controlling the distribution of the message to at least one of the plurality of controllers.

20. A system comprising:
memory configured to store mapping and instructions executable by the processor, the mapping data specifying each of a plurality of nodes and each of at least one service to which each of the plurality of nodes is associated, the instructions comprising:
logic configured to receive a message according to a messaging protocol, the message including a service address that includes a service identifier, a domain identifier and a mask, the logic being configured to apply the mask of the message to determine at least one recipient node of the plurality of nodes to which the message is to be communicated, the logic also being configured to communicate the message to at least one recipient node via a corresponding service interface selected according to the service identifier.

21. The system of claim 20, further comprising the plurality of nodes connected to a device that includes the memory and the processor, wherein the plurality of nodes comprises a plurality of controllers in a cable access network.

22. The system of claim 21, each of the plurality of controllers servicing a plurality of downstream nodes, selected groups of the downstream nodes being arranged into predetermined service groupings, the mask being programmable to identify each of the service groupings or at least a subset of the plurality of downstream nodes.

23. The system of claim 22, wherein each of the controllers further comprises endpoint mapping data that specifies a distribution for the message that varies depending on the mask, each of the controllers being configured to control distribution of the message to at least one of the service groupings or the subset of the plurality of downstream nodes based on the mask and the endpoint mapping data.

24. The system of claim 21, further comprising a control plane service configured to provide the message to the device via the messaging protocol, such that the logic of the device controls translation, routing and distribution of the message to at least one recipient controller based on applying the mask to the mapping data.
